(19) United States
(12) Patent Application Publication
(10) Pub. No.: US 2003/0074460 A1
(43) Pub. Date: Apr. 17, 2003

(54) Proprietary protocol for communicating network variables on a control network

(76) Inventors: Michael Soemo, Lombard, IL (US); Pierre DeSmul, Wilmette, IL (US); Mark Gagner, West Chicago, IL (US); Geoffrey D. Nass, Schaumburg, IL (US)

Correspondence Address: Siemens Corporation, Intellectual Property Department, 186 Wood Avenue South, Iselin, NJ, 08830, US

(21) Appl. No.: 09/967,338

(22) Filed: Sep. 28, 2001

(51) Int. Cl. G06F 15/16

(52) U.S. Cl. 709/230

(57) ABSTRACT

A proprietary communication protocol communicates data relating to network variables in a LON control network that has a plurality of device controllers for controlling a plurality of network devices and a system controller for controlling the device controllers. The protocol includes a message identification field for communicating one of a plurality of predefined messages and a protocol identification field for identifying the plurality of predefined messages as being communicated via said proprietary communication protocol. The messages include a message for subscribing for notification of changes in a value of at least one select network variable.

### BACKGROUND

The present invention generally relates to communication protocols used in control networks, and more particularly to a proprietary protocol for communicating network variables in a LON control network.

It is known in the control systems industry, especially in building control systems, to employ a control network to allow various system components to communicate with each other. Until recently, communication between the components in the network was handled through proprietary protocols developed by the control network developers/manufacturers. Increasingly, however, the control networks are now being implemented with open communication standards such as LonTalk®. These communication protocols permit system components that are produced by different manufacturers to communicate with each other, thus providing the network designers the flexibility to choose system components from various sources.

Known control systems typically include one or more system controllers that are connected via a control network to device controllers that operatively control network devices. The system controllers typically transmit commands to the device controllers via the network for operating the network devices, and also receive data from the device controllers regarding status and other information about the network devices that may be of interest to the system controller for making decisions. The device controllers in turn communicate with the network devices in response to the commands from the system controllers or for performing control functions not directly commanded by the system controllers.

A problem associated with the known control system arrangements, such as those built around a LON control network, is that the communication between the system controller and the device controllers, and between the device controllers the control devices must be conducted via the open protocol of the system network. These protocols do not always have the capacity to provide the support necessary for implementing complex and increased functionalities required by some control systems, such as a Heating/Ventilation/Air Conditioning (HVAC) system, for example. The known control system arrangements also limit designers' creativity in solving problems or expanding the capabilities of the system controller, because the designers are confined to the protocol of and the type of data provided by the network in place. Addition of new control applications to the control system is also complicated for the same reasons.

### SUMMARY OF THE INVENTION

The present invention is directed to a communication protocol for communicating data in a LON control network between network device controllers and a network system controller, and also between two-or more device controllers. The communication protocol in accordance With the present invention is adapted to be embedded in the existing network open protocol and provides enhanced capabilities for communication data in the LON control network.

### BRIEF DESCRIPTION OF THE DRAWINGS

FIG. 1 block diagram of a control system that uses the present communication protocol;

FIG. 2 is an illustration of common data fields that are selectively included in messages transmitted using the present communication protocol;

FIG. 3 is a NV IO protocol message format for a MSG_ID_NVIO_CREATE message;

FIG. 4 is a NV IO protocol message format for a MSG_ID_NVIO_SUBSCRIBE message;

FIG. 5 is a NV IO protocol message format for a MSG_ID_NVIO_UNSUBSCRIBE message;

FIG. 6 is a NV IO protocol message format for a MSG_ID_NVIO_UNSUBSCRIBE_ALL message;

FIG. 7 is a NV IO protocol message format for a MSG_ID_NVIO_UPDATE_SERVER message;

FIG. 8 is a NV IO protocol message format for a MSG_ID_NVIO_UPDATE_NV message;

FIG. 9 is a NV IO protocol message format for a MSG_ID_NVIO_POLL_NV message;

FIG. 10 is a NV IO protocol message format for a MSG_ID_NVIO_SET_OVERRIDE message;

FIG. 11 is a NV IO protocol message format for a MSG_ID_NVIO_CLEAR_OVERRIDE message;

FIG. 12 is a NV IO protocol message format for a MSG_ID_NVIO_REQUEST_REPORT message;

FIG. 13 is a NV IO protocol message format for a MSG_ID_NVIO_CANCEL_REPORT message;

FIG. 14 is a NV IO protocol message format for a MSG_ID_NVIO_QUERY_NODE message;

FIG. 15 is a NV IO protocol message format for a MSG_ID_APP_INFO message;

FIG. 16 is a NV IO protocol message format for a MSG_ID_NVIO_UPDATE_CLIENT message;

FIG. 17 is a NV IO protocol message format for a MSG_ID_NVIO_POLLED_NV_RESPONSE message;

FIG. 18 is a NV IO protocol message format for a MSG_ID_NVIO_OVERRIDE_REPORT message;

FIG. 19 is a NV IO protocol message format for a MSG_ID_NVIO_NODE QUERY_RESPONSE message; and,

FIG. 20 is a NV IO protocol message format for a MSG_ID_APPLICATION_ERROR message.

### DETAILED DESCRIPTION

Broadly stated, the present invention is directed to a proprietary communication protocol which communicates data relating to network variables in a LON control network that has a plurality of device controllers for controlling a plurality of network devices and one or more system controllers for coordinating and controlling the device controllers. The protocol includes a message identification field for communicating one of a plurality of predefined messages and a protocol identification field for identifying the plurality of predefined messages as being communicated via said proprietary communication protocol. The messages include a message for subscribing for notification of changes in a value of at least one select network variable.

In accordance with another aspect of the present invention, a control system for controlling a plurality of network devices in a LON control network using network variables includes a plurality of device controllers in communication with the network devices for controlling the network devices. The control system also includes at least one system controller for controlling the device controllers, and a corresponding network variable server in communication with each of the device controllers and the system controller for sending and receiving a plurality of predefined messages relating to at least one select network variable to and from the device controllers and the system controller via a proprietary communication protocol. The proprietary communication protocol includes a protocol identification field for identifying the plurality of predefined messages as being communicated via the proprietary communication protocol, and a message identification field communicating one of the plurality of predefined messages. The messages include a message sent by one of the device controllers to one of the network variable servers for subscribing for notification of changes in a value of one of the select network variables.

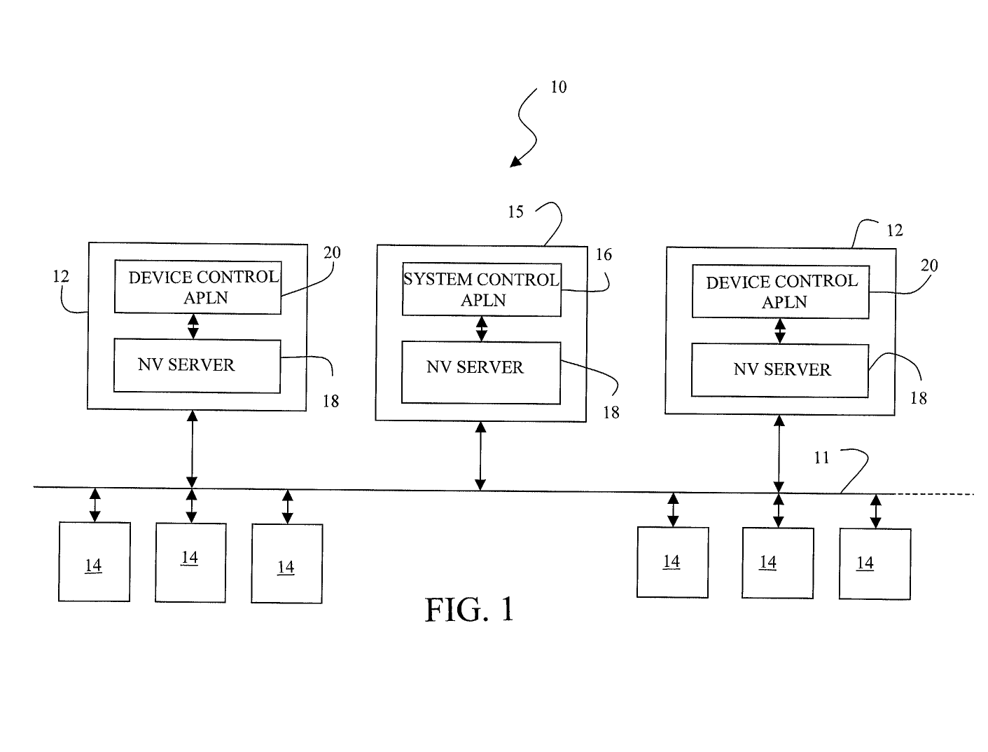

Turning now to FIG. 1, a control system in which the present communication protocol is implemented is designated at 10, and includes a LON control network 11, a plurality of device controllers 12 (two shown) that are network compliant for controlling various network devices 14 that are connected to the network, and a plurality of system controllers 15 (one shown) in communication with and for controlling the device controllers. These network devices 14 might be temperature sensors or heating/cooling coil valve actuators in a heating/ventilating/air conditioning (HVAC) system, for example.

The systems controllers 15 include a system control application 16 which is connected to a NV server 18 for transmitting and receiving data or network variables (NV) of the LON control network using the network variable input/output (NV 10) protocol of the present invention. Each of the device controllers 12 also includes a NV server 18, and a device control application 20 for processing NVs for controlling the network devices 14. In the device control application 20, the NVs are processed such that one or more of input NVs (NVIs) are subjected to a control algorithm or logic which is appropriate to the specific purpose of the device controller. The NVs that are output (NVOs) from the device control application 20 are used to control the network devices such as, for example, valve actuators, dampers, fans, etc. in a HVAC system.

The present NV IO protocol is used to communicate NV values between a single NV server 18 and the system control application 16 and one or more device control applications 20 (“NV clients”). Accordingly, the device control applications 20 may reside in a different device controller 12 than the NV server 18 maintaining the NVs of interest to the device control application. Generally, the NV values propagated by the NV server 18 represent changes in or updates of the NV values relating to the network devices 14 controlled by the device controllers 12. The NV clients (device control application or system control application) “subscribe ” for these changes or updates in the NV values from the NV server 18 that maintains the subscribed NVs. The NV IO protocol is preferably embedded in the open network protocol of the control network 11, i.e., the LonTalk® protocol, in the “explicit messages” specifically designated for incorporation of proprietary communication messages.

It should be understood that each device controller 12 represents a logical network “node” and accordingly, a single NV server 18 exists at each node. The system control application 16 and its corresponding NV server 18 also constitutes a node. Thus, a NV client may reside on the same or different network node as the NV server 18 holding the NVs that the clients are subscribed to. A NV client may also subscribe to NVs that reside on multiple NV servers 18.

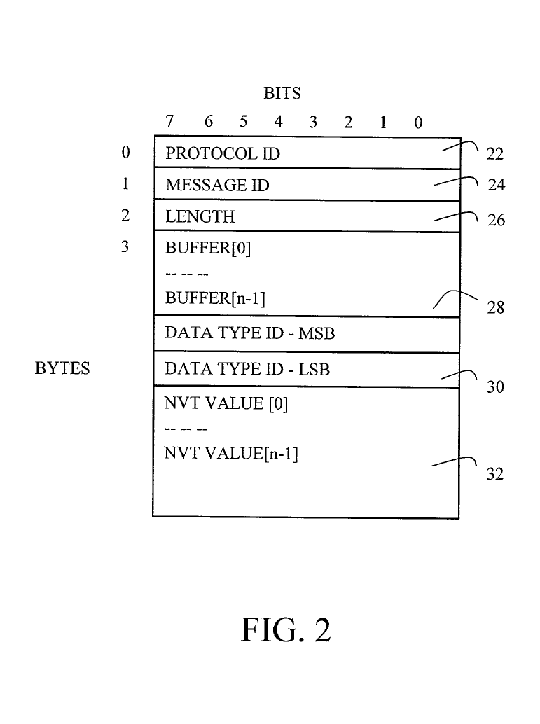

Turning now to FIG. 2, all NV IO protocol messages in accordance with the present invention include a protocol ID field 22. Each message type has a corresponding unique message identification (ID) that is stored in the message ID field 24. In the preferred embodiment, the NV IO protocol includes the following predefined message types which are sent from the NV client to the NV server 18. The corresponding unique message IDs are also listed.

| MESSAGE TYPE | MESSAGE ID |
|---|---|
| Create NV | MSG_ID_NVIO_CREATE |
| Subscribe for NV Updates | MSG_ID_NVIO_SUBSCRIBE |
| Unsubscribe for NV | MSG_ID_NVIO_UNSUBSCRIBE |
| Updates | |
| Unsubscribe for All NV | MSG_ID_NVIO_UNSUBSCRIBE_ALL |
| Updates | |
| Update NV at Server | MSG_ID_NVIO_UPDATE_SERVER |
| Update NV | MSG_ID_NVIO_UPDATE_NV |
| Poll NV | MSG_ID_NVIO_POLL_NV |
| Set Override | MSG_ID_NVIO_SET_OVERRIDE |
| Clear Override | MSG_ID_NVIO_CLEAR_OVERRIDE |
| Request Override Report | MSG_ID_NVIO_REQUEST_REPORT |
| Cancel Override Report | MSG_ID_NVIO_CANCEL_REPORT |
| Request | |
| Query Node | MSG_ID_NVIO_QUERY_NODE |
| Application Info message | MSG_ID_APP_INFO |

The following predefined message types along with their corresponding unique message IDs are sent from the NV server 18 to the NV clients.

| MESSAGE TYPE | MESSAGE ID |
|---|---|
| Update NV at Client | MSG_ID_NVIO_UPDATE_CLIENT |
| Polled NV Response | MSG_ID_NVIO_POLLED_NV_RESPONSE |
| Override Report | MSG_ID_NVIO_REPORT |
| Node Query | MSG_ID_NVIO_NODE_QUERY_RESPONSE |
| Response | |
| Command NAK | MSG_ID_APPLICATION_ERROR |

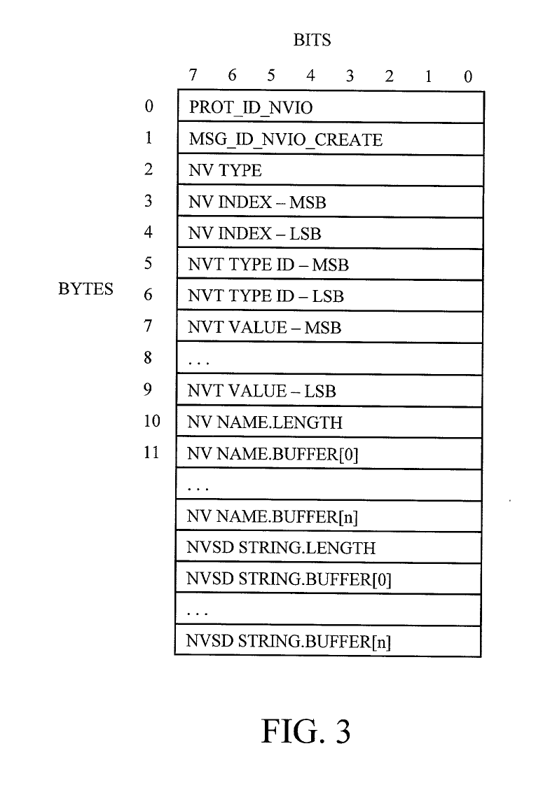

The NV IO protocol messages preferably have a serialized data structure, i.e., its bytes are stored in a predefined order. The preferable order is big endian, or the storing the most significant byte (MSB) of the field first. The messages are also of variable length to compensate for variable length data, e.g., those containing data strings and/or an NV values whose format is defined by various LON specific data types. For messages containing data strings, a length field 26 indicates the byte size of the buffer field 28 that holds the string, which immediately follows the length field. The messages which have an NV value defined by LON specific data types such as a standard network variable type (SNVT), a user-defined network variable type (UNVT), a standard configuration parameter type (SCPT) or a user-defined configuration parameter type (UCPT) are identified by a data type ID field 30 followed by the NV value 32. It should be noted that these fields of the NV IO protocol messages are shown only as way of example, and that not all these fields are included in all the predefined messages. The order of these fields as shown in FIG. 3 are also shown as an example, and that they may be in a different order in specific messages.

Turning now to FIG. 3, an NV IO protocol message for creating an NV is identified by MSG_ID_NVIO_CREATE. This message is sent from a device control application 20 to a NV server 18 to provide the data needed to create an NV for use by the NV clients in the control system 10. In addition to the protocol ID and the message fields described above, the MSG_ID_NVIO_CREATE message includes an NV TYPE field for defining the type of NV to be created. For example, a “0” in this field might indicate that a NV should be an input network variable or NVI, a “1” might indicate an output network variable or NVO and a “2” might indicate a network configuration item or NCI for configuring a node. The message also includes an NV INDEX field which identifies the NV that is to be created by the NV server 18.

An NVT TYPE ID field identifies the data type (SNVT or UNVT type number) associated with the NV to be created. A NVT VALUE field holds the actual value of the NV to be created. The message also includes a NV NAME.LENGTH field indicating the length of the variable text string name of a NV and a NV NAME.BUFFER field for the name itself in text string. Also included is an NVSD STRING.LENGTH field for indicating the length of the text string of self-documentation associated with the NV in the NVSD STRING.BUFFER field. The NV's self-documentation provides LONMark specific information for the NV, such as mapping the NV to a LON object on a network node.

It should be noted that the fields of the NV IO protocol messages having the same name are used for the same purpose in all messages, and once described, generally will not be specifically repeated for each message unless they aid in better understanding of these messages.

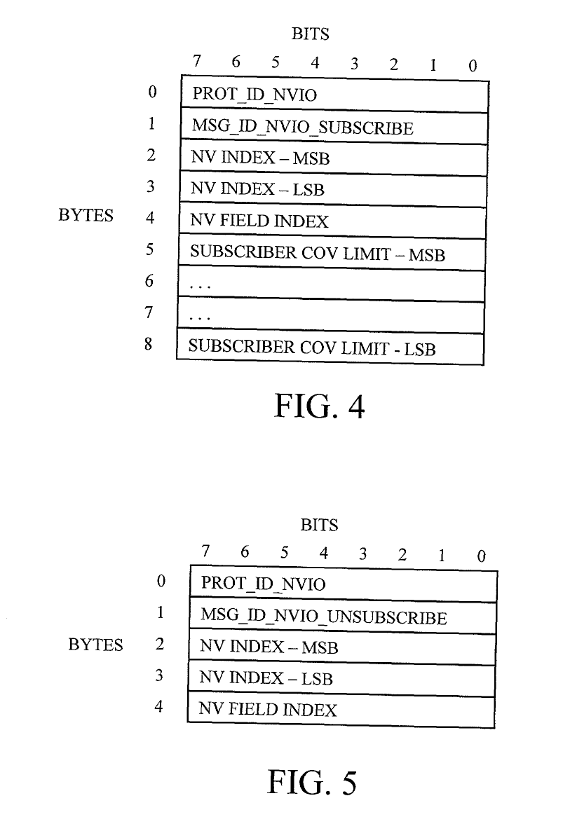

Turning now to FIG. 4, a message having an ID of MSG_ID_NVIO_SUBSCRIBE is sent from a NV client to a NV server 18 to subscribe for changes in value (COVs) of a NV. The NV server 18 maintains a list of all the NV clients 18 that are subscribed for a COV of a particular NV and updates the NV clients whenever the value of the NV changes. In addition to the common fields described above, the MSG_ID_NVIO_SUBSCRIBE message includes a NV FIELD INDEX field for specifying the field of the NV of interest, since a NV may have multiple fields, depending on its NVT Type. The message also includes a SUBSCRIBER COV LIMIT field for providing the limit of the NV value beyond which the NV client is interested in receiving notices.

Turning now to FIG. 5, a message having an ID of MSG_ID_NVIO_UNSUBSCRIBE is sent from the NV client to the NV server 18 for canceling a COV subscription previously established with the NV server through the MSG_ID_NVIO_SUBSCRIBE message. The NV INDEX field specifies the NV, and the NV FIELD INDEX field identifies the field within the NV that is the subject of the subscription cancellation. Once the subscription is canceled, the NV server 18 will no longer notify the NV client of any changes in the value of the NV.

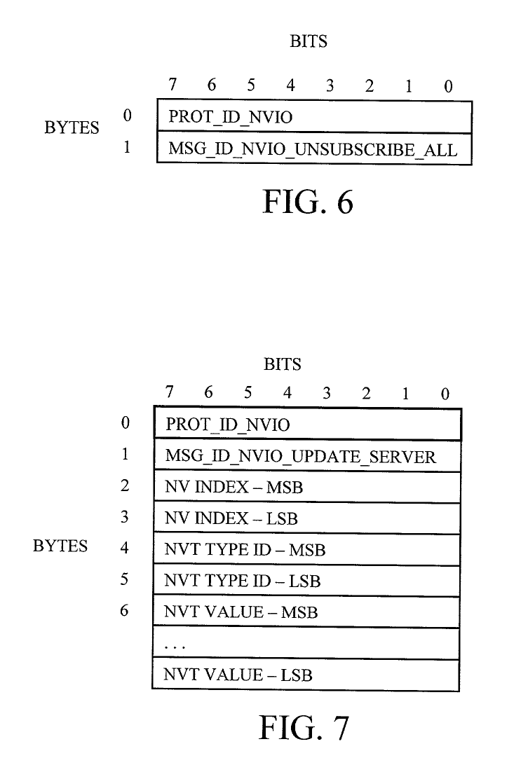

FIG. 6 shows the message format for canceling all subscription that the NV client issuing this message has established. The ID for this message is MSG_ID_NVIO_UNSUBSCRIBE_ALL. This message is broadcast from an NV client to all NV servers 18 to unsubscribe for COV notifications on all NV fields on all NV's that the NV client is currently subscribed to. This message would be typically be sent at shutdown and start-up by a NV client such as the system control application 16 (best shown in FIG. 1) to remove any remaining COV subscriptions. Each NV server 18 receiving this message will remove all COV subscriptions for the NV client sending the message, if any are present.

Turning now to FIG. 7, a MSG_ID_NVIO_UPDATE_SERVER message is sent from a NV client to a NV server 18 to notify the NV server that one or more fields in the NV has experienced a COV (it is up to the NV server 18 to determine which field(s) have been updated). This message is typically sent from a device control application 20 to update NVOs at the local NV server on the node. When this message is received, the NV server 18 will update its copy of the NV, and then notify each NV client that is subscribed for this updates to this NV, if the COV limit for the subscription is exceeded on the fields that were updated (see MSG_ID_NVIO_SUBSCRIBE message above). The NV server 18 (via the network client 28 in FIG. 2) will also update the NV at the LON network level, in order to propagate the updated NV value from the NVO to any NVI's bound at the LON-level to the NVO.

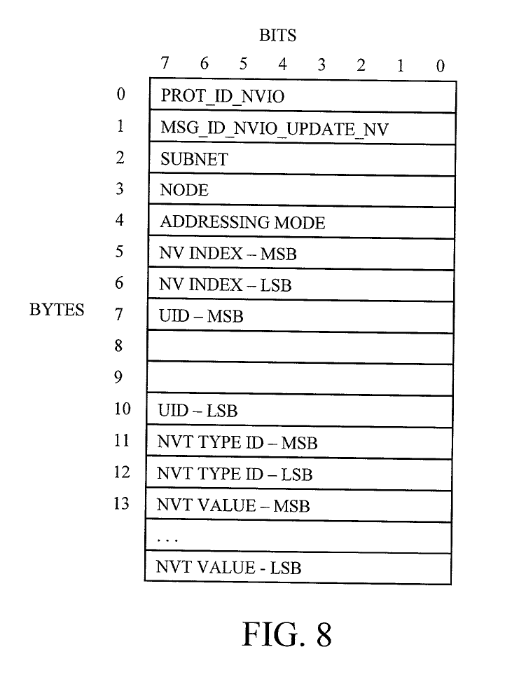

Turning now to FIG. 8, a MSG_ID_NVIO_UPDATE_NV message is sent from a NV client to a NV server 18 to instruct the NV server to update the value of a specified NV, NCI, or CP with the specified value. This message is preferably sent from the system control application 16 to its local NV server 18 on the node to update local and remote NV's, NCI's, and CP's. The remote NV is updated via the network client 28 shown in FIG. 2. The message includes a SUBNET and NODE fields for specifying the logical address of the network node containing the NV on the network 10, and an ADDRESSING MODE that indicates whether this is a NVI, NCI, or CP that is being updated. In addition to the common fields described above with respect to the messages presented above, the MSG_ID_NVIO_UPDATE_NV message includes an UID (unique ID) field that is used to further identify NCI's and CP's on remote network nodes.

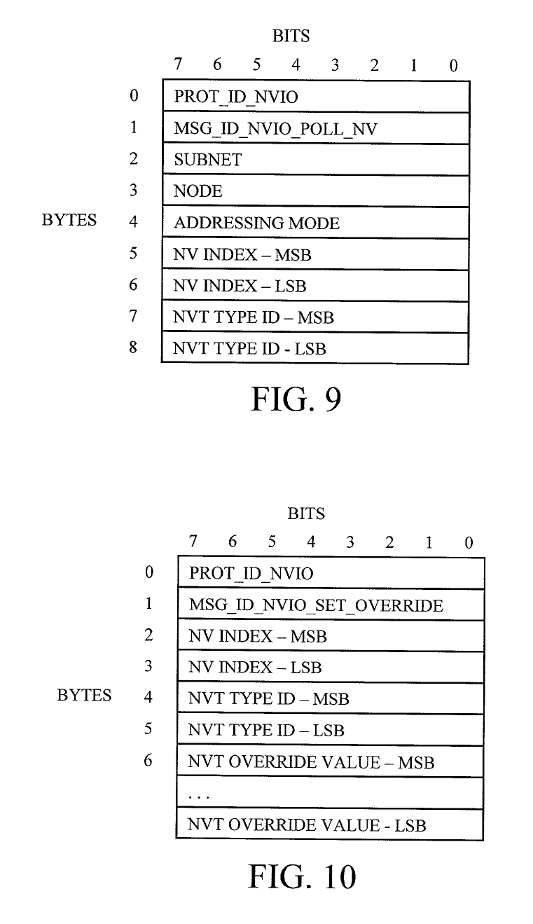

Turning now to FIG. 9, a MSG_ID_NVIO_POLL_NV message is sent from a NV client to a NV server 18 to instruct the NV server to retrieve the value of the NV, NCI, or CP specified by the SUBNET, NODE, NV INDEX, and NVT TYPE ID fields of the message. The ADDRESSING MODE field specifies whether this is a NV, NCI, or CP. If this NV resides within the NV server on the specified network node, the NV server responds by sending a message containing the current NV value back to the NV client.

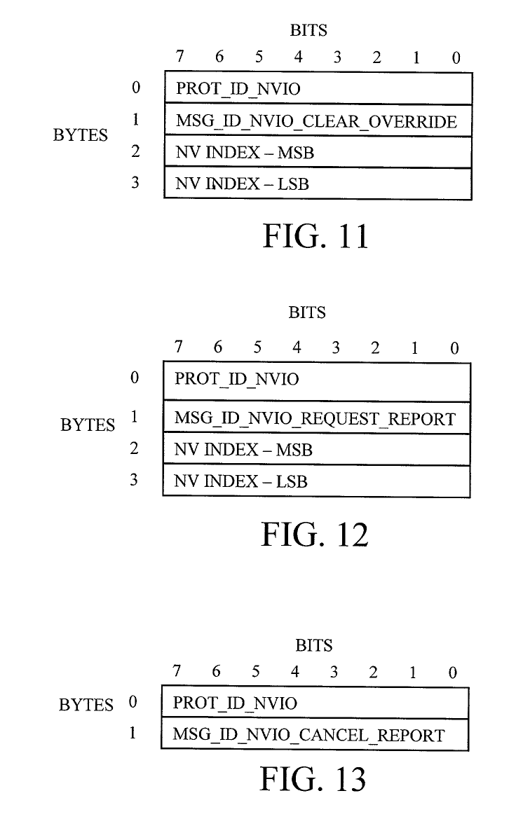

Turning now to FIG. 10, a MSG_ID_NVIO_SET_OVERRIDE message is sent from a NV client (typically the system control application 16) to a NV server 18 to override a specific NV in the NV server. This message overwrites the existing NV value with the value in the NVT OVERRIDE VALUE field, which becomes the new NV value until it is cleared by a MSG_ID_NVIO_CLEAR_OVERRIDE message shown in FIG. 11. When the MSG_ID_NVIO_SET_OVERRIDE message is received, the NV server.18 updates its record to indicate that the NV value has been overridden, and then sends a message (a MSG_ID_NVIO_UPDATE_CLIENT discussed below) as an acknowledgement to each NV client that is subscribed for updates on the NV being overridden. If there is already an override on the NV, the new override will overwrite the old override, i.e. the old override does not need to be cleared first with the MSG_ID_NVIO_CLEAR_OVERRIDE message.

The MSG_ID_NVIO_CLEAR_OVERRIDE message is sent from a NV client to a NV server 18 to clear an override on a specific NV that has been previously overridden. The MSG_ID_NVIO_CLEAR_OVERRIDE message can be sent by any NV client, and not just the NV client that initially set the override. When this message is received, the NV server 18 updates its record to indicate that the override has been cleared and then sends a message (a MSG_ID_NVIO_UPDATE_CLIENT discussed below) as an acknowledgement to each NV client that is subscribed for updates on the NV whose override was cleared.

Turning now to FIG. 12, a MSG_ID_NVIO_REQUEST_REPORT message is sent from a NV client (typically the system control application 16) to a NV server 18 to determine if a specific NV is overridden, or to determine all the NV's that are overridden at the NV server. For example, the NV INDEX field with a “FFFFh” value requests a report on all NV overrides present at the NV server. The NV server 18 sends one or more report messages (MSG_ID_NVIO_OVERRIDE_REPORT message described below) to the NV client in response to this report request.

FIG. 13 shows a MSG_ID_NVIO_CANCEL_REPORT message format for canceling the previously sent MSG_ID_NVIO_REQUEST_REPORT message. When received, the NV server 18 will stop sending any remaining override report messages to the NV client.

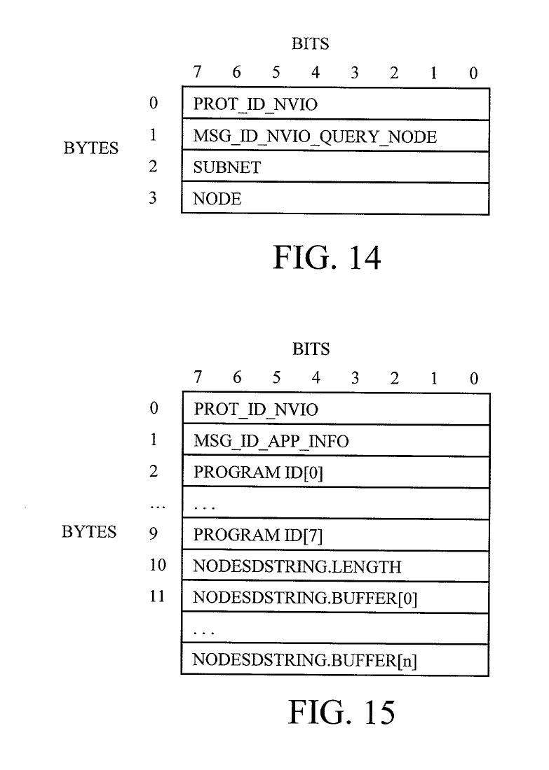

FIG. 14 is a format of a MSG_ID_NVIO_QUERY_NODE message sent from the system control application 16 to its local NV server 18 on the node to determine the status of a node in the control network 11 as specified by the SUBNET and NODE fields In response to this message the local NV server 18 will query the specified node (via a known LON mechanism) and send a status report message (a MSG_ID_NVIO_QUERY_RESPONSE message described below) back to the system control application 16.

FIG. 15 is a format of a MSG_ID_APP_INFO message sent from a NV client (typically a device control application 20) to a NV server 18 to provide the data needed to initialize the program ID and node self-documentation associated with a control application. The program ID is a LON construct that is used to identify the type of device at the network node. The node self-documentation string is a LON construct that is used to provide information about the LON objects on the network node.

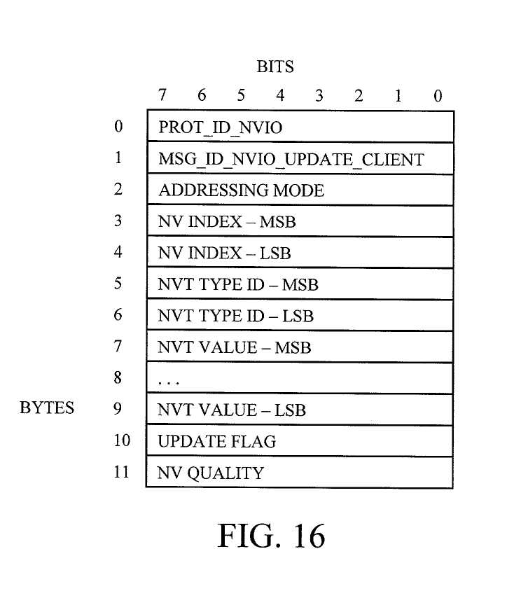

FIG. 16 is a format of a MSG_ID_NVIO_UPDATE_CLIENT message sent from a NV server 18 to one or more NV clients to notify the NV client(s) that one or more fields in the NV maintained by the NV server has experienced a COV or a COQ (it is up to the NV client(s) to determine which field(s) have been updated). This message is typically sent from a NV server to a device control application 20 or the system control application 16 to update the value of a NV with the NV client(s). For a COV, the NV server 18 will only notify the NV client(s) that are subscribed for COV updates for the particular NV field(s) that has experienced the COV, and whose subscription COV limit has been exceeded by the COV. For a COQ, the NV server will notify all NV clients that are subscribed for COV updates on any NV fields in the NV.

If the NV is currently overridden, then the value in the NVT VALUE field in this message will be set to the override value of the NV. Otherwise, the NVT VALUE in this message will be set to the current value of the NV. It should be noted that this message is also sent to a NV client in response to the MSG_ID_NVIO_SUBSCRIBE, the MSG_ID_NVIO_POLL_NV, the MSG_ID_NVIO_SET_OVERRIDE, and the MSG_ID_NVIO_CLEAR_OVERRIDE messages discussed above.

In addition to the common message fields described above, the MSG_ID_NVIO_UPDATE_CLIENT message also includes an UPDATE FLAG field for specifying the type of change that has occurred. For example, a “1” in this field might indicate that a COV has occurred, a “2” might indicate that a COQ has occurred, and a “3” that both COV and COQ have occurred. For both COV and COQ updates, the current value of the NV is in the NVT VALUE field, and the NV QUALITY field holds values that describe the state of the NV. A “0” in this field might indicate that the quality is bad, a “C0” might mean that the quality is good, and a “D8” might indicate that the NV has been overridden, for example.

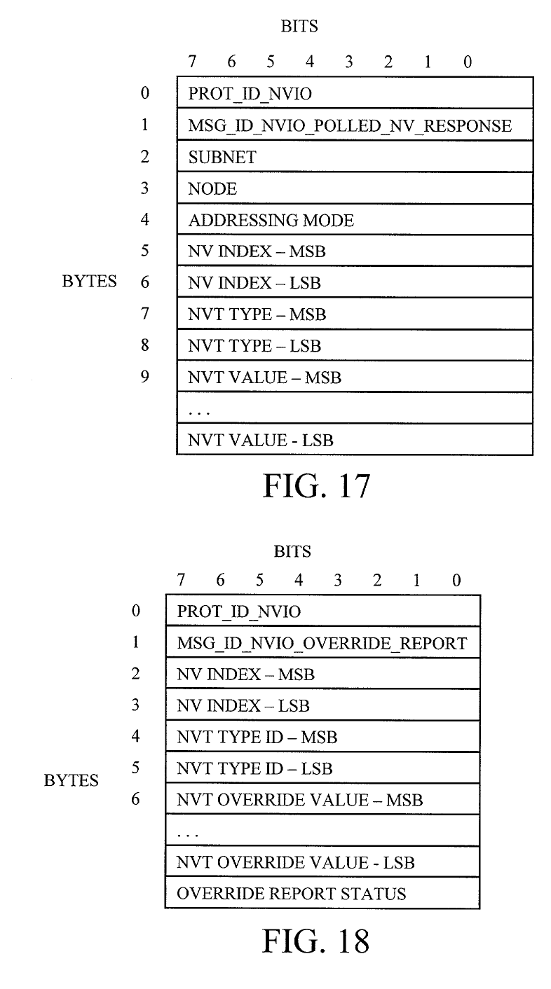

FIG. 17 is a format of a MSG_ID_NVIO_POLLED_NV_RESPONSE message sent from a NV server 18 to a NV client in response to a previously sent MSG_ID_NVIO_POLL_NV message by a NV client. The message includes, in addition to the common fields described above, the NVT VALUE field for transmitting the current NV value of the specified NV.

FIG. 18 is a form at of a MSG_ID_NVIO_OVERRIDE_REPORT message sent by a NV server 18 in response to a previously sent MSG_ID_NVIO_REQUEST_REPORT message from a NV client. Among the common message fields described above, this message includes the NVT OVERRIDE VALUE field for transmitting the value that was used to override the previous NV value. The MSG_ID_NVIO_OVERRIDE_REPORT message also includes a OVERRIDE REPORT STATUS field for reporting the status of the override. In the preferred embodiment, a “0” in this field indicates that the NV server 18 has received the override report request and has successfully processed it. A “1” in the field relays the same status as the “0”, but also that the subject NV is the last NV in the NV server that has been overridden.

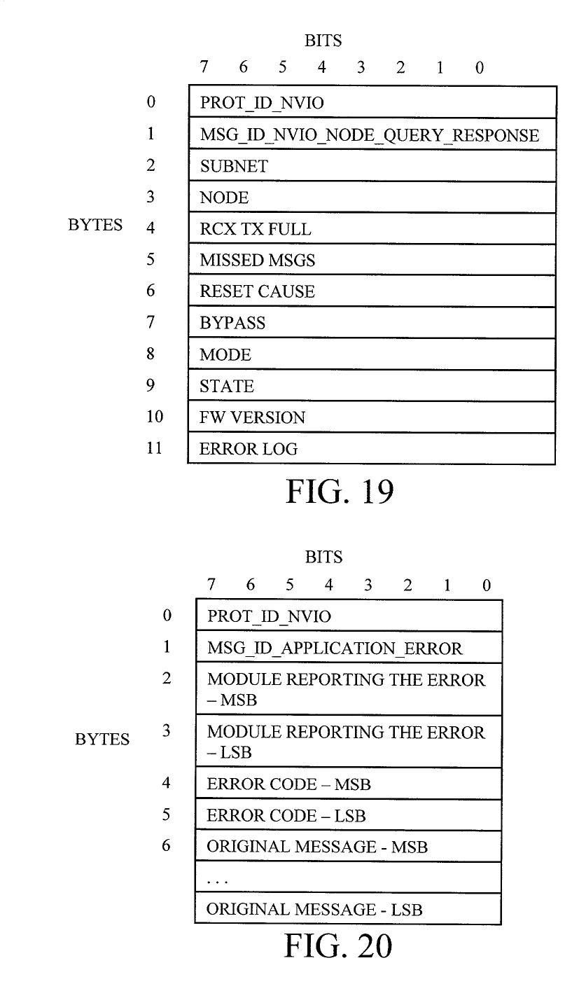

FIG. 19 is a format of a MSG_ID_NVIO_NODE_QUERY_RESPONSE message sent by the NV server 18 in response to a previously sent MSG_ID_NVIO_QUERY_NODE message from a NV client. The SUBNET and NODE fields identify the network node that was queried. The RCX TX FULL, MISSED MSGS, RESET CAUSE, BYPASS, MODE, STATE, FW VERSION, and ERROR LOG fields are identical to the same fields in the LonTalk “Query Status Response” network diagnostic message that is returned to the NV server 18 when the NV server queries a network node (in response to a MSG_ID_NVIO_QUERY_NODE message).

FIG. 20 is a format of a MSG_ID_APPLICATION_ERROR message sent from a NV server 18 to a NV client to report that the NV server was unable to execute the specified command from the NV client. In the preferred embodiment, this message is sent for each error condition. The MODULE REPORTING THE ERROR field identifies the software module (i.e., the NV server) reporting the error. The ERROR CODE identifies the type of error that has occurred (that prevented the original command from being executed at the NV server). The ORIGINAL MESSAGE field contains the original message sent to the NV server that generated the MSG_ID_APPLICATION_ERROR message.

From the foregoing description, it should be understood that an improved communication protocol for a control network has been shown and described which has many desirable attributes and advantages. The NV IO protocol is advantageously employed in a LON control network and is adapted to be embedded into the standard LonTalk® open communication protocol of the control network. In this manner, the NV IO protocol provides additional control capabilities to the control system not offered by the standard protocol.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims. Various features of the invention are set forth in the appended claims

What is claimed is:

1. A proprietary communication protocol for communicating data relating to network variables in a LON control network having a plurality of device controllers for controlling a plurality of network devices and a system controller for controlling the device controllers, said protocol comprising:
a message identification field for communicating one of a plurality of predefined messages;
a protocol identification field for identifying said plurality of predefined messages as being communicated via said proprietary communication protocol; and,
wherein said plurality of messages include a message for subscribing for notification of changes in a value of at least one select network variable.

2. The proprietary communication protocol as defined in claim 1 wherein said proprietary communication protocol is embedded in an open standard communication protocol of the LON control network.

3. The proprietary communication protocol as defined in claim 1 wherein said predefined messages are transmitted in a variable length serialized data structure.

4. The proprietary communication protocol as defined in claim 3 wherein said serialized data structure includes a data field indicating a length of data relating to said at least one select network variable and a data field holding said data.

5. The proprietary communication protocol as defined in claim 1 wherein said protocol includes a field for referencing said select network variable by a unique index value.

6. The proprietary communication protocol as defined in claim 1 wherein said protocol includes a field for indicating a data type of said value of said select network variable.

7. The proprietary communication protocol as defined in claim 6 wherein said protocol includes a field for communicating said value of said select network variable.

8. The proprietary communication protocol as defined in claim 1 wherein said protocol includes a field for referencing said at least one select network variable via a text name.

9. The proprietary communication protocol as defined in claim 8 wherein said protocol includes a field for indicating a length of said text name.

10. The proprietary communication protocol as defined in claim 1 wherein said predefined messages include a message for creating a new network variable.

11. The proprietary communication protocol as defined in claim 1 wherein said predefined messages include a message for canceling said subscription for notification of changes in said value of one of said at least one select network variable.

12. The proprietary communication protocol as defined in claim 1 wherein said predefined messages include a message for canceling said subscription for notification of changes in said value of all of said at least one select network variable.

13. The proprietary communication protocol as defined in claim 1 wherein said predefined messages include a message for sending a notification that said value of said at least one select network variable has changed.

14. The proprietary communication protocol as defined in claim 13 wherein said predefined messages include a message including instructions for updating said value of said at least one select network variable.

15. The proprietary communication protocol as defined in claim 1 wherein said predefined messages include a message including instructions for retrieving a current value of a specified one of the network variables.

16. The proprietary communication protocol as defined in claim 15 wherein said predefined messages include a message including said current value of said specified one of the network variables instructed to retrieve by said data retrieve message.

17. The proprietary communication protocol as defined in claim 1 wherein said predefined messages include a message including instructions for overriding an existing value of a specified one of the network variables.

18. The proprietary communication protocol as defined in claim 17 wherein said predefined messages include a message including a status of said override performed on said existing data of said specified one of the network variables.

19. The proprietary communication protocol as defined in claim 17 wherein said predefined messages include a message including instructions for canceling said overriding instructions.

20. The proprietary communication protocol as defined in claim 17 wherein said predefined messages include a message requesting a report as to whether said specified one of the network variables has been overridden.

21. The proprietary communication protocol as defined in claim 18 wherein said predefined messages include a message including instructions for canceling said request for said override report.

22. The proprietary communication protocol as defined in claim 1 wherein said predefined messages include a message for initializing a program ID and node self-documentation.

23. The proprietary communication protocol as defined in claim 1 wherein said predefined messages include a message for requesting a status of a select node on the control network.

24. The proprietary communication protocol as defined in claim 23 wherein said predefined messages include a message communicating said status of said select node requested by said status request message.

25. The proprietary communication protocol as defined in claim 1 wherein said predefined messages include a message for reporting that a task requested by at least one of said plurality of predefined messages cannot be processed.

26. A control system for controlling a plurality of network devices in a LON control network using network variables, said system comprising:
a plurality of device controllers, each including a device control application, in communication with the network devices for controlling the network devices;
at least one system controller including a system control application for controlling said device controllers; and,
a corresponding network variable server in communication with each of said device control applications and said system control application for sending and receiving a plurality of predefined messages relating to at least one select network variable to and from said device control applications and said system control application via a proprietary communication protocol;
said proprietary communication protocol including a protocol identification field for identifying said plurality of predefined messages as being communicated via said proprietary communication protocol, and a message identification field communicating one of said plurality of predefined messages;
wherein said plurality of messages include a message sent by one of said device control applications or said system control application to one of said network variable servers for subscribing for notification of changes in a value of said at least one select network variable.

27. The control system as defined in claim 26 wherein said predefined messages include a message sent by said one of said device control applications or said system control application to said one of said network variable server for canceling said subscription for notification of changes in a value of said select network variable.

28. The control system as defined in claim 26 wherein said predefined messages include a message sent by a select device control application or said system control application to all said network variable servers for canceling any subscription for notification of changes in value of any of said network variables.

29. The control system as defined in claim 26 wherein said predefined messages include a message sent by a select device control application or said system control application to a select network variable server for notifying said select network variable server that a value of one of the network variables has changed.

30. The control system as defined in claim 29 wherein said select network variable server updates said value of one of the network variables and sends a message to any of said device control applications or said system control application that are subscribed for notification of change of value of said one of the network variables to update said value of said one of the network variables at said any of said device control applications or said system control application with a new value contained in said update message.

31. The control system as defined in claim 26 wherein said predefined messages include a message sent by a select device control application or said system control application to a select network variable server, including instructions for retrieving a value relating to a select network variable in said select network variable server.

32. The control system as defined in claim 31 wherein said predefined messages include a message sent by said select network variable server to said select device control application or said system control application including said value relating to said select network variable specified by said retrieve message.

33. The control system as defined in claim 26 wherein said predefined messages include a message sent by a select device control application or said system control application to select network variable server, including instructions for overriding an existing value of said select network variable.

34. The control system as defined in claim 33 wherein said predefined messages include a message sent by said select network variable server to said select device control application or said system control application, including status of an override performed on said existing value of said select network variable.

35. The control system as defined in claim 33 wherein said predefined messages include a message sent by said select device control application or said system control application to said select network variable server including instructions for canceling said overriding instructions.

36. The control system as defined in claim 35 wherein said predefined messages include a message sent by said select device control application or said system control application to said select network variable server requesting a report as to whether said select network variable has been overridden.

37. The control system as defined in claim 36 wherein said predefined messages include a message sent by said select device control application or said system control application to said select network variable server containing instructions for canceling said request for said override report.

38. The control system as defined in claim 26 wherein said predefined messages include a message sent by said select device control application or said system control application to said select network variable server for initializing a program ID and node self-documentation.

39. The control system as defined in claim 26 wherein said predefined messages include a message sent from said system control application to a corresponding network variable server for a status of a select node on the control network.

40. The control system as defined in claim 39 wherein said predefined messages include a message sent by said corresponding network variable server to said system control application communicating said status of said select node requested by said system control application.

41. The control system as defined in claim 26 wherein said predefined messages include a message sent by a select network variable server to a select device control application or said system control application for reporting that a task requested by said select device controller through at least one of said plurality of predefined messages cannot be processed.
